(19) United States
(12) Patent Application Publication
(10) Pub. No.: US 2023/0154325 A1
(43) Pub. Date: May 18, 2023

(54) DRIVING ASSISTANCE APPARATUS

(71) Applicant: Honda Motor Co., Ltd., Tokyo (JP)

(72) Inventors: Hiroshi Kamakura, Wako-shi (JP); Hiroki Nakajima, Wako-shi (JP); Masataka Izawa, Wako-shi (JP); Kazuki Yamoto, Wako-shi (JP); Yasuhiko Awamura, Wako-shi (JP)

(21) Appl. No.: 17/983,195

(22) Filed: Nov. 8, 2022

(30) Foreign Application Priority Data
Nov. 15, 2021 (JP) 2021-185412

(51) Int. Cl. G08G 1/0967; B60W 50/14; B60W 40/04; B60W 30/18; H04W 4/44

(52) U.S. Cl. CPC G08G 1/096783; B60W 30/18154; B60W 30/18159; B60W 40/04; B60W 50/14; H04W 4/44; B60W 2050/143; B60W 2050/146; B60W 2520/06; B60W 2555/60; B60W 2556/50

(57) ABSTRACT

A driving assistance apparatus including a detection part detecting surroundings of a subject vehicle and a microprocessor. The microprocessor is configured to perform acquiring traffic light information including a remaining time period until a traffic light installed at an intersection is switched, controlling a notification part so as to notify a driver of the subject vehicle of switching information of the traffic light from a first mode capable of passing through the intersection to a second mode incapable of passing through the intersection, and determining whether there is a space into which the subject vehicle is movable in an area after passing through the intersection based on the surroundings. The microprocessor is configured to perform the controlling including controlling the notification part so as to notify the driver of warning information together with the switching information when it is determined that there is not the space.

### CROSS-REFERENCE TO RELATED APPLICATION

This application is based upon and claims the benefit of priority from Japanese Patent Application No. 2021-185412 filed on Nov. 15, 2021, the content of which is incorporated herein by reference.

### BACKGROUND OF THE INVENTION

### Field of the Invention

This invention relates to a driving assistance apparatus that assists a driving operation of a driver.

### Description of the Related Art

Conventionally, as an apparatus of this type, there is a known apparatus that receives signal information transmitted from a DSRC transmitter provided in a traffic light, obtains a lighting state and a change timing of the traffic light from the received signal information, and displays the lighting state and the change timing on a display device of the vehicle to notify a driver of the lighting state and the change timing. Such an apparatus is described, for example, in Japanese Unexamined Patent Publication No. 2004-171459 (JP2004-171459A). In the apparatus described in JP2004-171459A, a time-to-switch of the traffic light is displayed on the display device.

However, if the driver starts the vehicle after the switching of the traffic light to a green light is notified, the vehicle may stay at the intersection and cannot move after the vehicle has passed a stop line depending on a traffic situation, which may hinder the traffic flow. Therefore, it is desired to have a configuration in which a decrease in the smoothness of the traffic is suppressed while improving the safety of the traffic without hindering the traffic flow in the vicinity.

### SUMMARY OF THE INVENTION

An aspect of the present invention is a driving assistance apparatus including: a notification part notifying a driver of a subject vehicle of information; a detection part detecting a surrounding situation of the subject vehicle; and an electronic control unit including a microprocessor and a memory connected to the microprocessor. The microprocessor is configured to perform acquiring traffic light information including information on a remaining time period until a traffic light installed at an intersection is switched, the traffic light being switchable to a plurality of modes including a first mode indicating a state in which the subject vehicle is prohibited from passing through the intersection and a second mode indicating a state in which the subject vehicle is permitted to pass through the intersection, controlling the notification part so as to notify the driver of switching information on switching of the traffic light from the first mode to the second mode based on the traffic light information, and determining whether there is a space into which the subject vehicle is movable, in an area after passing through the intersection, based on the surrounding situation detected by the detection part. The microprocessor is configured to perform the controlling including controlling the notification part so as to notify the driver of warning information together with the switching information when it is determined that there is not the space in the area.

### BRIEF DESCRIPTION OF THE DRAWINGS

The objects, features, and advantages of the present invention will become clearer from the following description of embodiments in relation to the attached drawings, in which:

FIG. 1 is a diagram showing an example of a travel scene to which a driving assistance apparatus according to an embodiment of the present invention is applied;

FIG. 2A is a diagram showing an example of a display screen of a display device included in the driving assistance apparatus according to the embodiment of the present invention;

FIG. 2B is a diagram showing another example of the display screen of the display device included in the driving assistance apparatus according to the embodiment of the present invention;

FIG. 3 is a diagram showing another example of the travel scene to which the driving assistance apparatus according to the embodiment of the present invention is applied;

FIG. 4 is a block-diagram illustrating a configuration of a main part of the driving assistance apparatus according to the embodiment of the present invention;

FIG. 5 is a diagram for explaining a processing by a movement determination unit in FIG. 4;

FIG. 6 is a diagram showing an example of the display screen of the display device in a situation different from those in FIGS. 2A and 2B; and

FIG. 7 is a flowchart illustrating an example of processing executed by a controller in FIG. 4.

### DETAILED DESCRIPTION OF THE INVENTION

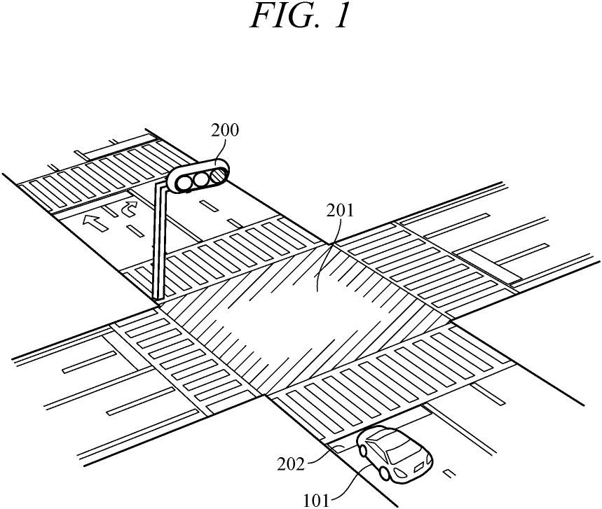

Hereinafter, an embodiment of the present invention is explained with reference to FIGS. 1 to 7. A driving assistance apparatus according to an embodiment of the present invention is configured to display switching information on a traffic light on a display part of a display device. The display device is provided in a vehicle, and the switching information of the traffic light is notified to a driver via the display part.

FIG. 1 is a diagram showing an example of travel scene to which the driving assistance apparatus according to the embodiment is applied. FIG. 1 illustrates an example of the vehicle 101 stopping at an intersection 201 at which a traffic light 200 is installed (indicated by hatching). More specifically, the subject vehicle 101 stops at the foremost portion of the intersection 201, more specifically, in front of a stop line 202 facing the traffic light 200. Incidentally, the intersection 201 refers to a portion where two or more roads intersect (an area indicated by hatching in FIG. 1). In FIG. 1, an intersection 201 of four-way roads (cross roads) in which roads extend in four directions in a state where two roads are orthogonal is shown, but the intersection to which the present embodiment is applied may be three-way roads (T-road), five-way roads, or the like.

In FIG. 1, for convenience, the single traffic light 200 is shown. The traffic light 200 is configured to sequentially switch between a red light indicating a stop command, a green light (a blue light) indicating that traveling is possible, and a yellow light indicating that traveling is possible but safe stop is difficult at a predetermined cycle. In FIG. 1, the light of the traffic light is red. The configuration of the traffic light is not limited to this. For example, the traffic light may be configured to switch between the red light and the green light. The traffic light may be an arrow traffic light which indicates a travelable direction by an arrow, rather than the light color is switched. Hereinafter, for convenience, a state indicating the stop command of the traffic light is referred to as a stop command state (a state in which the subject vehicle is prohibited from passing through the intersection), and a state indicating that the vehicle is travelable is referred to as a travelable state (a state in which the subject vehicle is permitted to pass through the intersection). The vehicle acquires switching information of the traffic light via a road-to-vehicle communication, for example. The switching information includes information on the remaining time period until the traffic light changes from the stop command state to the travelable state. The switching information includes information on a remaining time period until the traffic light switches from the stop command state to the travelable state.

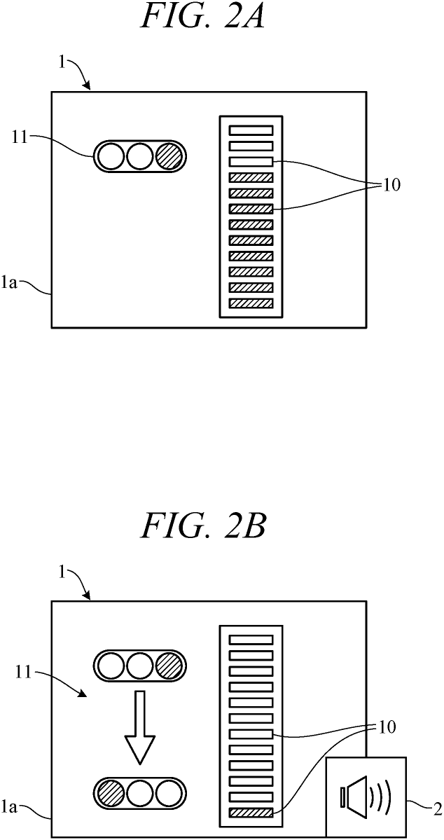

FIG. 2A is a front view illustrating an example of a display screen 1a of the display device 1 that displays the switching information of the traffic light 200. The display device 1 is incorporated in an instrument panel provided in a front portion of a vehicle interior while facing the driver. For example, the display device 1 is disposed on a side of a meter screen of the instrument panel. A display of a navigation unit disposed in the vicinity of the instrument panel can also be used as the display device 1. The display device 1 may be configured by a head-up display that projects an image onto a windshield or a panel provided in the vicinity of the windshield.

As illustrated in FIG. 2A, the display device 1 includes a plurality of (n) display portions 10 disposed side by side in a vertical direction on the display screen 1a. The configurations (sizes and shapes) of the display portions 10 are the same as each other. The display portions 10 may be gradually decreased or increased in size downward. In FIG. 2A, the display portions 10 are disposed with a gap therebetween in the vertical direction, but the display portions 10 may be disposed without a gap. In other words, the display portions 10 may be disposed while being adjacent to each other.

Each display portions 10 has a light-emitting diode (LED) disposed inside the display screen 1a. The display portion 10 is turned on by the LED being turned on. The display portion 10 is turned off by the LED being turned off. The display portion 10 is blinked by the LED being blinked. Instead of the LED, another light capable of turning on and off and blinking may be used as the display portion 10. The display screen 1a may be configured by a liquid crystal display, an organic electro luminescence display, or the like, and the display portion 10 may be configured as an image. In FIG. 2A, a lighting state of each display portion 10 is indicated by hatching for convenience.

Turning on and off of the display portion 10 is controlled by the in-vehicle controller 20 (FIG. 4). FIG. 2A is a diagram illustrating an example of the lighting state of the display portion 10 during a time period from when the traffic light 200 is in the stop command state (for example, red) until when the traffic light 200 switches to the travelable state (for example, green). Hereinafter, the time period from when the traffic light 200 is in the stop command state until when the traffic light 200 switches to the travelable state is referred to as a switching time period T for convenience, and a time period (T/n) obtained by dividing the switching time period T by the number n of the display portions 10 is referred to as a unit switching time period Δt. The unit switching time period Δt is, for example, five seconds.

Although not illustrated, all the n display portions 10 are turned on immediately after switching to the stop command state. Every time the unit switching time period Δt elapses from that time point, the display portions 10 are turned off one by one in order from the top. FIG. 2A corresponds to a time point at which 3 × Δt seconds have elapsed after switching to the stop command state, and the three display portions 10 are turned off. On the display screen 1a, a display portion 11 indicating a lighting state (lighting of a red light) of the traffic light 200 is provided on a side of the display portion 10. The unit switching time period Δt required to turn off the display portion 10 may be not set to be constant, and may be lengthened or shortened as the traffic light 200 approaches the travelable state.

FIG. 2B is a front view illustrating an example of the display screen 1a at a time point when a time period has elapsed in the state of FIG. 2A. FIG. 2B corresponds to a time point a predetermined time period t (for example, 6 seconds) before the traffic light 200 becomes the travelable state, and only the lowermost display portion 10 among the n display portions 10 is turned on, and the rest is turned off. The predetermined time period t is set to a range of Δt ≤ t < 2 × Δt. In the following description, it is assumed that the predetermined time period t is equal to or substantially equal to the unit switching time period Δt. The time point the predetermined time period t before the traffic light 200 becomes the travelable state is referred to as a time point immediately before the switching. At the time point immediately before the switching, the display portion 11 on the side of the display portion 10 displays an image indicating a change in the lighting state of the traffic light 200, that is, an image indicating a change from the lighting of the red light to the lighting of a green light.

At this time, a predetermined warning sound is generated from a speaker in a vehicle interior according to a command from the in-vehicle controller 20, and the driver is notified of the switching timing of the traffic light 200. Thus, a driver can recognize that the traffic light 200 will switch to the travelable state (green) soon. As a result, it is possible to prevent a start delay of the subject vehicle 101 at the time of switching to the green light, and a smooth traffic flow is possible.

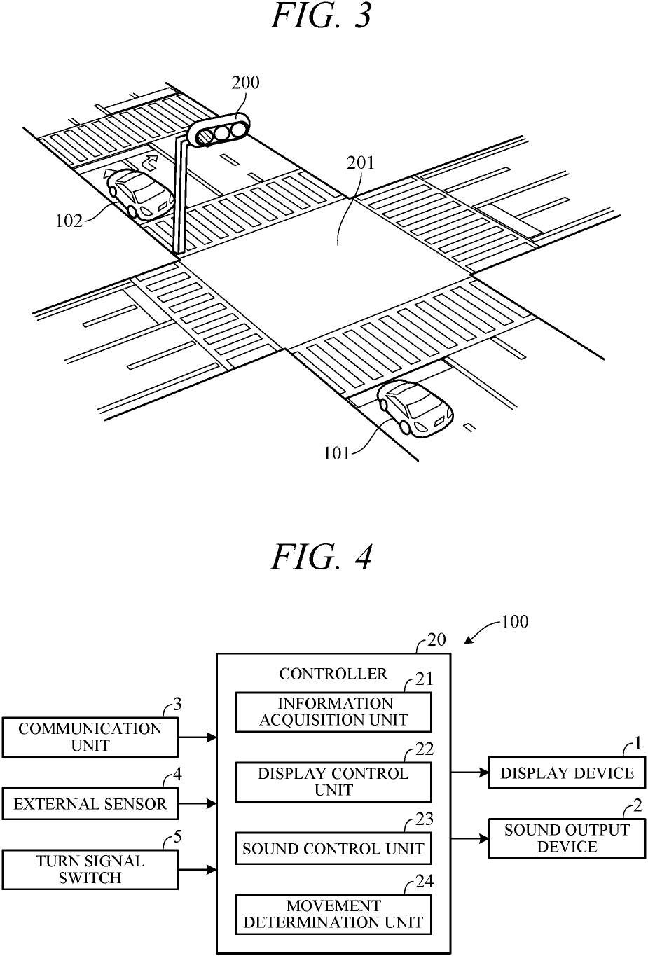

However, there is a case where even when the traffic light 200 switches to the green light, the subject vehicle 101 cannot immediately enter the intersection 201. FIG. 3 is a diagram illustrating an example of such a traffic situation. In FIG. 3, a straight traveling direction of the subject vehicle 101 is congested, and another vehicle 102 exists in an area beyond the intersection 201. Therefore, there is a possibility that after entering the intersection 201, the subject vehicle 101 cannot move forward beyond the intersection 201, and the subject vehicle 101 may be left behind at the intersection 201 and disturbs the traffic flow. Therefore, in order to prevent the subject vehicle 101 from entering the intersection 201 and being left behind when the switching of the traffic light 200 from the stop command state to the travelable state is notified, the present embodiment configures the driving assistance apparatus 100 as follows.

FIG. 4 is a block-diagram schematically illustrating a configuration of a main part of the driving assistance apparatus 100 according to the embodiment of the present invention. As shown in FIG. 4, the driving assistance apparatus 100 includes a controller 20, and a communication unit 3, an external sensor 4, a turn signal switch 5, a display device 1 and a sound output device 2 which are communicably connected to the controller 20, respectively.

The communication unit 3 is configured to be capable of wirelessly communicating with a communication device such as an optical beacon or a radio beacon provided on the road, that is, capable of road-to-vehicle communication. The communication unit 1 receives, from the communication device provided on the road, the traffic light information on the traffic light located in the traveling direction of the subject vehicle, i.e., the traffic light information on the traffic light installed at the intersection where the subject vehicle passes next. The traffic light information includes information on the switching time period T of the traffic light and the remaining time period until the traffic light switches from the stop command state (for example, red) to the travelable state (for example, green). The communication unit 3 is further configured to be capable of inter-vehicle communication with other vehicles surrounding the subject vehicle, and receives vehicle information such as vehicle speed data and position data of the other vehicle via the inter-vehicle communication.

The external sensor 4 is a sensor that detects an external condition of the subject vehicle. Specifically, the external sensor 4 is configured by a camera that includes an image pickup device such as a CCD or a CMOS and captures an image of the surroundings of the subject vehicle, a radar that detects a position of an object around the subject vehicle by emitting an electromagnetic wave and detecting a reflected wave, and a LIDAR that detects a position (a distance or a direction from the subject vehicle) of an object around the subject vehicle by emitting a laser beam and detecting a reflected light.

The turn signal switch 5 detects an operation of a direction indicator by a driver. The direction indicator is a device for indicating the direction to the surroundings at the time of the right-left turn or the course change of the subject vehicle, and is constituted by a turn signal lever or the like. Although not shown, a positioning sensor that receives a positioning signal transmitted from a positioning satellite such as a GPS satellite or a quasi-zenith satellite is also connected to the controller 20, and the current position of the subject vehicle can be calculated using the positioning information received by the positioning sensor.

The controller 20 includes an electronic control unit having a microprocessor and a memory connecting the microprocessor. More specifically, the controller 20 includes a computer including a CPU, a ROM, a RAM, and other peripheral circuits such as an I/O interface. The controller 20 includes, as functional components, an information acquisition unit 21, a display control unit 22, a sound control unit 23 and a movement determination unit 24.

The information acquisition unit 21 acquires, via the communication unit 3, the traffic light information transmitted from the communication device by the road-to-vehicle communication and the vehicle information transmitted from other vehicle by the inter-vehicle communication. Further, the information acquisition unit 21 acquires detection information of the external condition based on the signal from the external sensor 4 and operation information of the direction indicator based on the signal from the turn signal switch 5.

The display control unit 22 controls turning on and off of the display portion 10 on the basis of the traffic light information acquired by the information acquisition unit 21. In other words, the display control unit 22 calculates the switching time period T and the unit switching time period Δt. The switching time period T is from when the traffic light 200 is in the stop command state until when the traffic light 200 switches to the travelable state on the basis of the traffic light information. The unit switching time period Δt is obtained by dividing the switching time period T by the number n of the display portions 10. Then, the display control unit 22 controls the display device 1 so that when the traffic light 200 switches to the stop command state, all the display portions 10 are turned on, and thereafter, every time the unit switching time period Δt elapses after the traffic light 200 switches to the stop command state, the display portions 10 are turned off one by one from the top. The display control unit 22 controls the display device 1 so that at or after the time point immediately before the switching, that is, the time point the predetermined time period t before (unit switching time period Δt before) the traffic light 200 switches to the travelable state, only the lowermost display portion 10 is turned on.

The sound output device 2 is a device that outputs a sound from a speaker provided in the vehicle interior. The sound control unit 23 controls the sound output device 2 so that a predetermined warning sound is generated from the speaker at the time point immediately before the switching. Only the lowermost display portion 10 is turned on at the time point immediately before the switching, but the warning sound may be generated before or after the time point immediately before the switching.

At the time point immediately before the switching, the movement determination unit 24 predicts a direction in which the subject vehicle 101 travels after passing through the intersection 201 based on a signal from the turn signal switch 5. In other words, it is estimated that the subject vehicle 101 will turn right if the turn signal switch 5 for right-turn is on, it is estimated that the subject vehicle 101 will turn left if the turn signal switch 5 for left-turn is on, and it is estimated that the subject vehicle 101 will travel straight if both the turn signal switch 5 for right-turn and the turn signal switch 5 for left-turn are off. Furthermore, the movement determination unit 24 determines whether a space (movement space) into which the subject vehicle 101 can move exists in the area beyond the intersection 201 in the predicted traveling direction of the subject vehicle 101 on the basis of the signal from the external sensor 4.

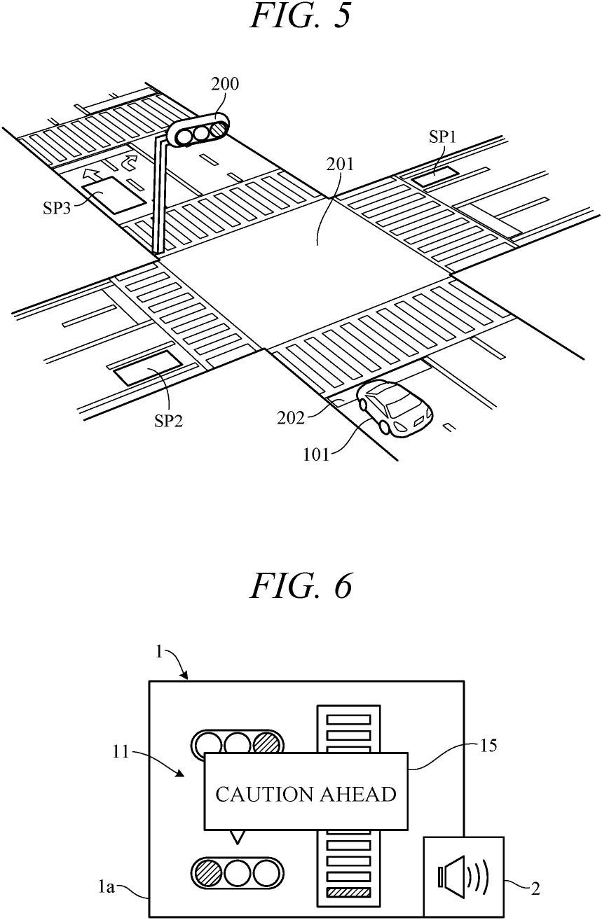

FIG. 5 is a diagram illustrating examples of the movement space. As illustrated in FIG. 5, the movement space when the subject vehicle 101 turns right is denoted by SP1, the movement space when the subject vehicle 101 turns left is denoted by SP2, and the movement space when the subject vehicle 101 travels straight is denoted by SP3. These spaces SP1 to SP3 are determined according to the size of the subject vehicle 101. When determining that an obstacle such as another vehicle exists in the spaces SP1 to SP3 in the predicted traveling direction of the subject vehicle 101 based on the signal from the external sensor 4 (FIG. 3), the subject vehicle 101 cannot move into the spaces SP1 to SP3. Therefore, the movement determination unit 24 determines that the movement space does not exist. Meanwhile, when determining that an obstacle does not exist in the spaces SP1 to SP3 in the predicted traveling direction of the subject vehicle 101, the movement determination unit 24 determines that the movement space exists.

There is a possibility that areas on the right side and the left side of the intersection 201 are shaded by a building or the like and the external sensor 4 cannot detect the presence or absence of the movement spaces SP1 and SP2. Therefore, the movement determination unit 24 may acquire the vehicle information of another vehicle via inter-vehicle communication, and detect the position of another vehicle from position data included in the vehicle information, whereby determine whether another vehicle exists in the spaces SP1 and SP2. Also for the space SP3 in front of the subject vehicle 101, whether another vehicle exists may be determined by the inter-vehicle communication.

The display control unit 22 changes the display of the display screen 1a according to a determination result of the movement determination unit 24 at the time point immediately before the switching. In other words, when it is determined that the movement space exists in the predicted traveling direction of the subject vehicle 101, as illustrated in FIG. 2B, the display of the display screen 1a is changed so that the lowermost display portion 10 is turned on and displayed and the display portion 11 on the side of the display portion 10 is caused to display a change in the lighting state of the traffic light 200. Meanwhile, when it is determined that the movement space does not exist in the predicted traveling direction of the subject vehicle 101, warning information is displayed on the display screen 1a.

FIG. 6 is a diagram illustrating an example of the display screen 1a in that case. As illustrated in FIG. 6, on the display screen 1a, a warning image 15 is displayed while being superposed on display images (display portions 10 and 11) in FIG. 2B. The warning image 15 includes a message that calls the driver’s attention to driving because the movement space does not exist ahead of the intersection 201. For example, the message “caution ahead” is highlighted in a display color different from the display of the display portions 10 and 11. Thus, the driver drives the subject vehicle 101 while paying more attention to the front than usual. The warning image 15 may be displayed at a position not overlapping the display portion 10. The warning information may be displayed on the display screen 1a by a means other than an image (for example, lighting of a lamp).

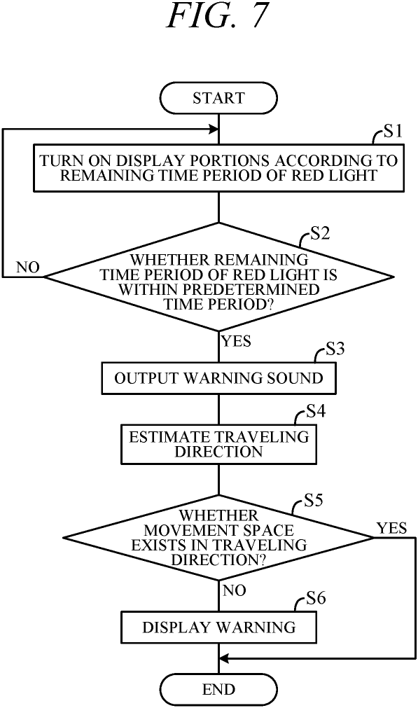

FIG. 7 is a flowchart illustrating an example of processing executed by the controller 20 (microprocessor) of FIG. 4. The processing illustrated in this flowchart is started when the traffic light information of the traffic light in the stop command state is received via, for example, the communication unit 3. The traffic light information includes information on a remaining time period from when light color of the traffic light is red until when the light color of the traffic light switches to green (referred to as a remaining time period of the red light). The remaining time period of the red light can also be calculated from the switching time period T included in the traffic light information and information on an elapsed time period after the traffic light is switched to the red light.

As illustrated in FIG. 7, first, in S1 (S: processing step), the controller 20 outputs a control signal to the display device 1 so that the display portions 10 are turned on according to the remaining time period of the red light. For example, in a state immediately after switching to the stop command state, that is, when the remaining time period of the red light is the switching time period T, the controller 20 outputs a control signal so that all the display portions 10 are turned on. Next, in S2, the controller 20 determines whether the remaining time period of the red light is within the predetermined time period t (unit switching time period Δt), that is, whether the time point immediately before the switching has come. In a case where a negative determination is made in S2, the processing returns to S1, and the controller 20 repeats similar processing. Thus, the display portions 10 are turned off sequentially from the top as a time period elapses.

In a case where a positive determination is made in S2, the processing proceeds to S3, and the controller 20 outputs a control signal to the sound output device 2 so that a predetermined warning sound, for example, “boing” or the like is generated from the speaker. Next, in S4, the controller 20 estimates the traveling direction of the subject vehicle 101 on the basis of a signal from the turn signal switch 5. Specifically, the controller 20 estimates that the subject vehicle 101 will turn right if the turn signal switch 5 for right-turn is on, estimates that the subject vehicle 101 will turn left if the turn signal switch 5 for left-turn is on, and estimates that the subject vehicle 101 will travel straight if both the turn signal switches 5 for right-turn and left-turn are off.

Next, in S5, the controller 20 determines whether the movement space into which the subject vehicle 101 can move exists beyond the intersection 201 in the traveling direction of the subject vehicle 101 estimated in S4 on the basis of the signal from the external sensor 4. The controller 20 may determine whether the movement space exists by acquiring position information of another vehicle via the inter-vehicle communication and using the acquired position information. In a case where a negative determination is made in S5, the processing proceeds to S6, and in a case where a positive determination is made, the processing passes S6 and is ended. In S6, the controller 20 outputs a control signal to the display device 1 so that the predetermined warning information such as “caution ahead” is displayed on the display screen 1a, and the processing ends.

The operation of the driving assistance apparatus 100 according to the present embodiment is summarized as follows. As illustrated in FIG. 1, when the subject vehicle 101 is stopped by the red light at the forefront of the intersection 201 where the traffic light 200 is installed, the display portions 10 are turned on according to the remaining time period of the red light (S1). In other words, as switching to the green light approaches with the lapse of a time period, the number of the display portions 10 that are turned on decreases. Thus, the driver can recognize the remaining time period from when the traffic light 200 is the red light until the traffic light 200 switches to the green light. When the remaining time period of the red light reaches the unit switching time period Δt (time point immediately before the switching), the predetermined warning sound is output from the speaker via the sound output device 2 (S3). Thus, even if the driver is not looking at the display screen 1a, the driver can easily recognize that the traffic light 200 will switch from the stop command state to the travelable state.

If the traveling direction of the subject vehicle 101 that is stopping at the intersection 201 is, for example, the straight traveling direction, and the movement space SP3 (FIG. 5) into which the subject vehicle 101 can move exists in the area beyond the intersection 201 at the time point immediately before the switching, the warning information is not displayed on the display screen 1a. In this case, even if the driver starts the subject vehicle 101 in accordance with the warning sound, the subject vehicle 101 is not left behind at the intersection 201, and it is possible to prevent the subject vehicle 101 from adversely affecting the traffic flow.

Meanwhile, if the movement space SP3 (FIG. 5) into which the subject vehicle 101 can move does not exist in the area beyond the intersection 201 at the time point immediately before the switching for a reason such as congestion, the warning image 15 such as “caution ahead” is displayed on the display screen 1a (S6). Thus, the driver can easily recognize that the movement space SP3 does not exist in front of the subject vehicle 101. Therefore, even if a sound indicating that the stop command state will switch to the travelable state is output, the driver does not start the subject vehicle 101 and waits until the movement space SP3 is generated. As a result, it is possible to prevent the subject vehicle 101 from being left behind at the intersection 201 and interfering with the traffic flow.

According to the present embodiment, the following operations and effects are achievable.

The driving assistance apparatus 100 includes the information acquisition unit 21, the display device 1, the external sensor 4, and the movement determination unit 24 (FIG. 4). The information acquisition unit 21 acquires the traffic light information including information on the remaining time period from when the traffic light 200 is the red light until the traffic light 200 switches to the green light. The traffic light 200 is installed at the intersection 201 and configured to be switchable between the red light indicating a stop command and the green light indicating possibility of traveling. The display device 1 notifies the driver of the subject vehicle 101 of switching information that the traffic light 200 switches from the red light to the green light on the basis of the traffic light information acquired by the information acquisition unit 21. The external sensor 4 detects a surrounding situation of the subject vehicle 101. The movement determination unit 24 determines whether the movement spaces SP1 to SP3 into which the subject vehicle 101 can move exist in an area after passing through the intersection 201 on the basis of the surrounding situation detected by the external sensor 4. When the movement determination unit 24 determines that the movement spaces SP1 to SP3 do not exist, the display device 1 displays the warning information together with the switching information (FIG. 7).

Thus, the driver starts the subject vehicle 101 while paying attention to a traffic jam situation ahead. Therefore, when the switching information that the traffic light 200 switches from the red light to the green light is notified, it is possible to prevent the subject vehicle 101 from entering the intersection 201 and being left behind at the intersection 201 without being able to pass through the intersection 201. In other words, it is possible to prevent the subject vehicle 101 from becoming unable to move after erroneously entering the intersection 201 even though the subject vehicle 101 cannot enter the intersection 201. As a result, it is possible to prevent the traffic flow from being obstructed and to achieve smooth traffic.

The driving assistance apparatus 100 includes the turn signal switch 5, and the movement determination unit 24 estimates the traveling direction of the subject vehicle 101 after passing through the intersection 201 based on the signal from the turn signal switch 5 before the subject vehicle 101 passes through the intersection 201 and determines whether the movement spaces SP1 to SP3 exist in the estimated traveling direction (FIG. 4). For example, when the subject vehicle 101 turns right, even if the movement space SP3 does not exist in the straight traveling direction, if the movement space SP1 exists in a right turning direction, the subject vehicle 101 can move through the intersection 201. Thus, it is not necessary to display the warning information. In consideration of this point, the presence or absence of the movement spaces SP1 to SP3 in the traveling direction is determined, and the warning information is displayed. Therefore, more useful information for a driver can be provided.

The driving assistance apparatus 100 includes the display device 1 that displays the information on the remaining time period of the red light included in the switching information of the traffic light 200. When the movement determination unit 24 determines that the movement spaces SP1 to SP3 do not exist, the driving assistance apparatus 100 displays the warning information on the display device 1 together with the information of the remaining time period of the red light (FIG. 6). Thus, when recognizing the remaining time period by looking at the display screen 1a, the driver can simultaneously recognize the occurrence of a warning of caution ahead, and can prevent overlooking of the warning information.

The driving assistance apparatus 100 includes the sound output device 2 (sound output part) that outputs the switching information of the traffic light 200 with the warning sound (FIG. 4). Thus, the driver can easily recognize timing at which the traffic light 200 switches to the green light.

The above embodiments can be modified into various forms. Several modifications will be described below. In the above embodiment, the information acquisition unit 21 acquires the traffic light information including the information on the remaining time period until the traffic light 200 is switched by the road-to-vehicle communication via the communication unit 3, but after detecting a vehicle position of the subject vehicle, the information acquisition unit may acquire the traffic light information corresponding to the vehicle position of the subject vehicle from an external server device. The traffic light information may be acquired by inter-vehicle communication. In the above embodiment, a red signal indicating a stop command, i.e., a state incapable of passing through an intersection is configured as a first mode, a green signal indicating that traveling is possible, i.e., a state capable of passing through the intersection is treated as a second mode, and the traffic light 200 is treated to be switchable from the first mode to the second mode. However, the first mode and the second mode are not limited to those described above.

In the above embodiment, the switching information of the traffic light 200 (for example, the information on the remaining time period of the red light as the first mode) is notified to the driver via the display device 1 as a display part and the sound output device 2 as a sound output part, but the configuration of a notification part is not limited to the above configuration. In the above embodiment, the warning information is notified by the warning image 15 as a character image, but the warning information may be notified by an illustration image or the like. The warning information may be notified by turning on a warning lamp or the like.

In the above embodiment, the surroundings of the subject vehicle are detected by the external sensor 4 or by the inter-vehicle communication, but the surroundings of the subject vehicle may be detected by another detection part. In the above embodiment, the movement determination unit 24 as a determination unit and an estimation unit estimates the traveling direction of the subject vehicle 101 after passing through the intersection 201, and then determines whether or not the movement space SP1 to P3 of the subject vehicle 101 exists in the traveling direction, but may determine whether or not the traveling space of the subject vehicle exists without estimating the traveling direction of the subject vehicle after passing through the intersection. Therefore, the configuration of a determination unit is not limited to the above configuration.

The present invention can also be used as a driving assistance method including

acquiring traffic light information including information on a remaining time period until a traffic light 200 installed at an intersection 201 is switched, the traffic light 200 being switchable to a plurality of modes including a first mode indicating a state in which the subject vehicle is prohibited from passing through the intersection and a second mode indicating a state in which the subject vehicle is permitted to pass through the intersection, notifying a driver of a subject vehicle 101 of switching information on switching of the traffic light 200 from the first mode to the second mode based on the traffic light information, detecting a surrounding situation of the subject vehicle 101, and determining whether there is a space SP1-SP3 into which the subject vehicle 101 is movable, in an area after passing through the intersection 201, based on the surrounding situation detected, wherein the notifying includes notifying the driver of warning information together with the switching information when it is determined that there is not the space in the area SP1-SP3.

The above embodiment can be combined as desired with one or more of the above modifications. The modifications can also be combined with one another.

According to the present invention, it is possible to prevent a subject vehicle from erroneously entering an intersection in accordance with switching information of a traffic light.

Above, while the present invention has been described with reference to the preferred embodiments thereof, it will be understood, by those skilled in the art, that various changes and modifications may be made thereto without departing from the scope of the appended claims.

What is claimed is:

1. A driving assistance apparatus comprising:
a notification part notifying a driver of a subject vehicle of information;
a detection part detecting a surrounding situation of the subject vehicle; and
an electronic control unit including a microprocessor and a memory connected to the microprocessor, wherein
the microprocessor is configured to perform
acquiring traffic light information including information on a remaining time period until a traffic light installed at an intersection is switched, the traffic light being switchable to a plurality of modes including a first mode indicating a state in which the subject vehicle is prohibited from passing through the intersection and a second mode indicating a state in which the subject vehicle is permitted to pass through the intersection;
controlling the notification part so as to notify the driver of switching information on switching of the traffic light from the first mode to the second mode based on the traffic light information; and
determining whether there is a space into which the subject vehicle is movable, in an area after passing through the intersection, based on the surrounding situation detected by the detection part, and
the microprocessor is configured to perform
the controlling including controlling the notification part so as to notify the driver of warning information together with the switching information when it is determined that there is not the space in the area.

2. The driving assistance apparatus according to claim 1, wherein
the microprocessor is further configured to perform
estimating a traveling direction of the subject vehicle after passing through the intersection, before the subject vehicle passes through the intersection, and
the microprocessor is configured to perform
the determining including determining whether there is the space in the traveling direction.

3. The driving assistance apparatus according to claim 2, further comprising
a turn signal switch detecting an operation of a direction indicator, wherein
the microprocessor is configured to perform
the estimating including estimating the traveling direction of the subject vehicle based on a signal from the turn signal switch.

4. The driving assistance apparatus according to claim 1, wherein
the notification part includes a display part displaying information on a remaining time period until the traffic light is switched from the first mode to the second mode, included in the switching information, and
the microprocessor is configured to perform
the controlling including controlling the display part so as to display the warning information together with the information on the remaining time period, when it is determined that there is not the space in the area.

5. The driving assistance apparatus according to claim 4, wherein
the microprocessor is configured to perform
the controlling including controlling the display part so as to display an image indicating the warning information superimposed on an image indicating the information on the remaining time period.

6. The driving assistance apparatus according to claim 1, wherein
the notification part includes a sound output part outputting a sound so as to notify the switching information.

7. The driving assistance apparatus according to claim 1, wherein
the microprocessor is configured to perform
the determining including determining whether there is the space in the area after passing through the intersection when the remaining time is equal to or smaller than a predetermined time.

8. A driving assistance apparatus comprising:
a notification part notifying a driver of a subject vehicle of information;
a detection part detecting a surrounding situation of the subject vehicle; and
an electronic control unit including a microprocessor and a memory connected to the microprocessor, wherein
the microprocessor is configured to function as
an information acquisition unit that acquires traffic light information including information on a remaining time period until a traffic light installed at an intersection is switched, the traffic light being switchable to a plurality of modes including a first mode indicating a state in which the subject vehicle is prohibited from passing through the intersection and a second mode indicating a state in which the subject vehicle is permitted to pass through the intersection;
a notification control unit that controls the notification part so as to notify the driver of switching information on switching of the traffic light from the first mode to the second mode based on the traffic light information acquired by the information acquisition unit; and
a determination unit that determines whether there is a space into which the subject vehicle is movable, in an area after passing through the intersection, based on the surrounding situation detected by the detection part, and wherein
the notification control unit controls the notification part so as to notify the driver of warning information together with the switching information when it is determined by the determination unit that there is not the space in the area.

9. The driving assistance apparatus according to claim 8, wherein
the microprocessor is further configured to function as
an estimation unit that estimates a traveling direction of the subject vehicle after passing through the intersection, before the subject vehicle passes through the intersection, and
the determination unit determines whether there is the space in the traveling direction estimated by the estimation unit.

10. The driving assistance apparatus according to claim 9, further comprising
a turn signal switch detecting an operation of a direction indicator, wherein
the estimation unit estimates the traveling direction of the subject vehicle based on a signal from the turn signal switch.

11. The driving assistance apparatus according to claim 8, wherein
the notification part includes a display part displaying information on a remaining time period until the traffic light is switched from the first mode to the second mode, included in the switching information, and
the notification control unit controls the display part so as to display the warning information together with the information on the remaining time period, when it is determined by the determination unit that there is not the space in the area.

12. The driving assistance apparatus according to claim 11, wherein
the notification control unit controls the display part so as to display an image indicating the warning information superimposed on an image indicating the information on the remaining time period.

13. The driving assistance apparatus according to claim 8, wherein
the notification part includes a sound output part outputting a sound so as to notify the switching information.

14. The driving assistance apparatus according to claim 8, wherein
the determination unit determines whether there is the space in the area after passing through the intersection when the remaining time is equal to or smaller than a predetermined time.

15. A driving assistance method comprising:
acquiring traffic light information including information on a remaining time period until a traffic light installed at an intersection is switched, the traffic light being switchable to a plurality of modes including a first mode indicating a state in which the subject vehicle is prohibited from passing through the intersection and a second mode indicating a state in which the subject vehicle is permitted to pass through the intersection;
notifying a driver of a subject vehicle of switching information on switching of the traffic light from the first mode to the second mode based on the traffic light information;
detecting a surrounding situation of the subject vehicle; and
determining whether there is a space into which the subject vehicle is movable, in an area after passing through the intersection, based on the surrounding situation detected, wherein
the notifying includes notifying the driver of warning information together with the switching information when it is determined that there is not the space in the area.
